(19) United States
(12) Patent Application Publication
(10) Pub. No.: US 2008/0168043 A1
(43) Pub. Date: Jul. 10, 2008

(54) SYSTEM AND METHOD FOR OPTIMIZING QUERY RESULTS IN AN ABSTRACT DATA ENVIRONMENT

(76) Inventors: Richard D. Dettinger, Rochester, MN (US); Frederick A. Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/621,376

(22) Filed: Jan. 9, 2007

(51) Int. Cl. G06F 17/30

(52) U.S. Cl. 707/4; 707/E17.017

(57) ABSTRACT

A method, system and article of manufacture for generating binary query results and, more particularly, for generating a binary result set from non-binary data. One embodiment comprises receiving a request for a binary result set for an object containing result fields, and operating on the object to generate the binary result set from non-binary result data associated with the result fields. Operating on the object comprises accessing at least one field definition for at least one of the result fields to retrieve one or more value constraints that define allowable values for the at least one result field. Using the one or more retrieved value constraints, the non-binary result data associated with the result fields is rendered in a binary format, whereby the binary result set is generated.

### CROSS-REFERENCE TO RELATED APPLICATIONS

This application is related to the following: commonly assigned, co-pending, U.S. Pat. No. 6,996,558, issued Feb. 7, 2006, titled “Application Portability and Extensibility through Database Schema and Query Abstraction;” and commonly assigned, co-pending U.S. patent application Ser. No. 11/005,418, filed Dec. 6, 2004, entitled “Abstract Query Plan”, each of which is incorporated by reference herein in its entirety.

### BACKGROUND OF THE INVENTION

1. Field of the Invention

The present invention generally relates to data processing and, more particularly, to generating binary query results.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) and application programming interfaces (API's) such as Java® Database Connectivity (JDBC). The term “query” denominates a set of commands for retrieving data from a stored database. Queries take the form of a command language, such as SQL, that lets programmers and programs select, insert, update, find out the location of data, and so forth.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity.

Query results are usually presented as sets of data records, the number of which can often be quite large (i.e., thousands of records). Often, a user will not examine each record of a given query result individually, but will instead execute one or more selected analysis routines on the complete query result to determine patterns or trends in the underlying data. However, such analysis routines frequently require binary result sets as input, i.e., result sets that are presented in binary form. A binary result set is a result set where only presence or absence of a given data point is represented using a binary value, but without indicating an actual value defining the given data point.

For instance, assume a sales manager who wants to determine trends and associations of items that customers of a given store buy. More specifically, the sales manager may want to determine which items customers frequently buy together. For the determination of corresponding patterns it is only necessary to know which items each customers buys, but not the exact quantity of the bought items. Thus, in a corresponding binary result set representing customer purchases, a binary value “1” represents each item bought by a customer and a “0” or null value represents those items that the customer does not buy.

However, data in query results that can be retrieved from underlying databases is frequently not in binary form. For instance, in clinical database environments having data about medical tests and diagnoses, corresponding query results tend to include more dimensional data. Such more dimensional data may take many different values, such as test results or established diagnoses, instead of only “1” and “0” or null. Unfortunately, such query results are not suitable for analysis by analysis routines that require binary result sets as input.

Therefore, there is a need in the art for techniques for generating binary query results in response to query execution.

### SUMMARY OF THE INVENTION

The present invention is generally directed to a method, system and article of manufacture for data processing and, more particularly, for generating binary query results.

One embodiment provides a computer-implemented method of generating a binary result set from non-binary data. The method comprises receiving a request for a binary result set for an object containing result fields, and operating on the object to generate the binary result set from non-binary result data associated with the result fields. Operating on the object comprises accessing at least one field definition for at least one of the result fields to retrieve one or more value constraints that define allowable values for the at least one result field. Using the one or more retrieved value constraints, the non-binary result data associated with the result fields is rendered in a binary format, whereby the binary result set is generated.

Another embodiment provides a computer-readable medium containing a program which, when executed by a processor, performs a process for generating a binary result set from non-binary data. The process comprises receiving a request for a binary result set for an object containing result fields, and operating on the object to generate the binary result set from non-binary result data associated with the result fields. Operating on the object comprises accessing at least one field definition for at least one of the result fields to retrieve one or more value constraints that define allowable values for the at least one result field. Using the one or more retrieved value constraints, the non-binary result data associated with the result fields is rendered in a binary format, whereby the binary result set is generated.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with the invention;

FIG. 2 is a relational view of software components used to manage query execution and to process query results, according to one embodiment of the invention;

FIGS. 3A-C are relational views of software components in one embodiment;

FIGS. 4-5 are flow charts illustrating the operation of a runtime component, in one embodiment;

FIG. 6 is a flow chart illustrating a method of managing query execution according to one embodiment of the invention;

FIG. 7 is an exemplary user interface illustrating creation of an abstract query in one embodiment;

FIG. 8 is a flow chart illustrating a method of managing processing of a query result in one embodiment;

FIG. 9 is a flow chart illustrating a method of processing an abstract query in one embodiment;

FIG. 10 is a flow chart illustrating a method of processing a query result in one embodiment; and

FIG. 11 is a flow chart illustrating a method of generating an optimized data structure in one embodiment.

### DETAILED DESCRIPTION OF THE PREFERRED EMBODIMENTS

### Introduction

The present invention is generally directed to a method, system and article of manufacture for generating binary query results and, more particularly, for generating a binary result set from non-binary data. In general, a binary result set is a result set where only presence or absence of a given data point is represented using a binary value, but without indicating an actual value defining the given data point. According to one aspect, in a given binary result set a binary value “1” represents a present data point and a “0” or null value represents the absence of a data point.

In one embodiment, a binary result set is generated for an object that contains result fields. Each result field is described by an underlying field definition. According to one aspect, the underlying field definitions of the result fields of a given object are defined by a data abstraction model that models physical data in an underlying database in a manner making a schema of the physical data transparent to a user of the abstraction model. A field definition that describes a given result field can include one or more value constraints on data stored in the underlying database that is associated with the given result field. Each value constraint defines allowable values for a respective result field.

In one embodiment, the object is a non-binary result set including non-binary result data for the result fields that is returned in response to a previously executed query. The object can further be a query requesting the non-binary result data using the results fields. In order to generate the binary result set for the object from the non-binary result data, one or more operations are performed on the object with respect to the result fields.

In one embodiment, the field definitions for the result fields are accessed to retrieve corresponding value constraints that define allowable values for the result fields. Thus, binary values can be used to indicate whether a given allowable value is included with the non-binary result data for a given result field. Accordingly, using the retrieved value constraints, the non-binary result data associated with the result fields is rendered in a binary format, whereby the binary result set is generated.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

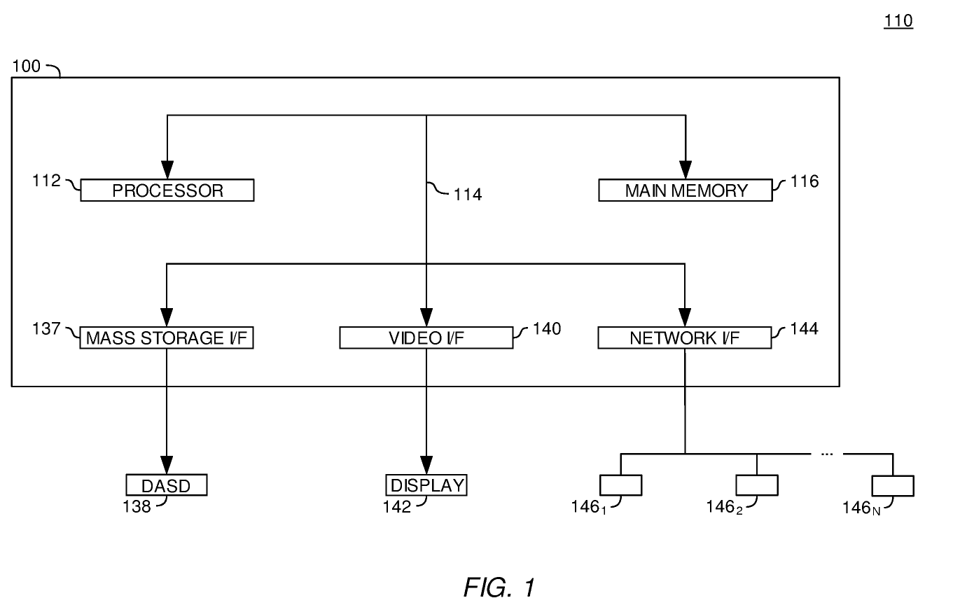

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to a plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Query and Query Result Processing Environment

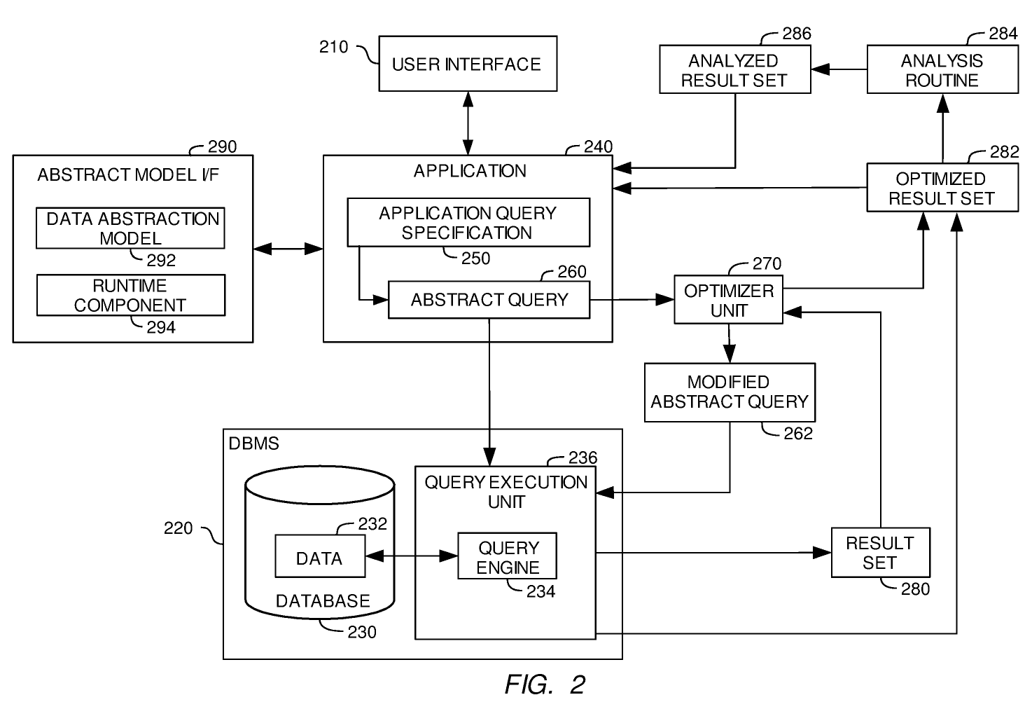

Referring now to FIG. 2, a relational view of software components in one embodiment is illustrated. The software components illustratively include a user interface 210, a DBMS 220, one or more applications 240 (only one application is illustrated for simplicity), an optimizer unit 270, one or more analysis routines 284 (only one analysis routine is illustrated for simplicity) and an abstract model interface 290. The abstract model interface 290 illustratively includes a data abstraction model 292 and a runtime component 294. The DBMS 220 illustratively includes a database 230 and a query execution unit 236 having a query engine 234.

The database 230 is shown as a single database having data 232, for simplicity. However, the database 230 can also be implemented by multiple databases which can be distributed relative to one another. Moreover, one or more databases can be distributed to one or more networked devices (e.g., networked devices 146 of FIG. 1). The database 230 is representative of any collection of data regardless of the particular physical representation of the data. A physical representation of data defines an organizational schema of the data. By way of illustration, the database 230 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of the data 232.

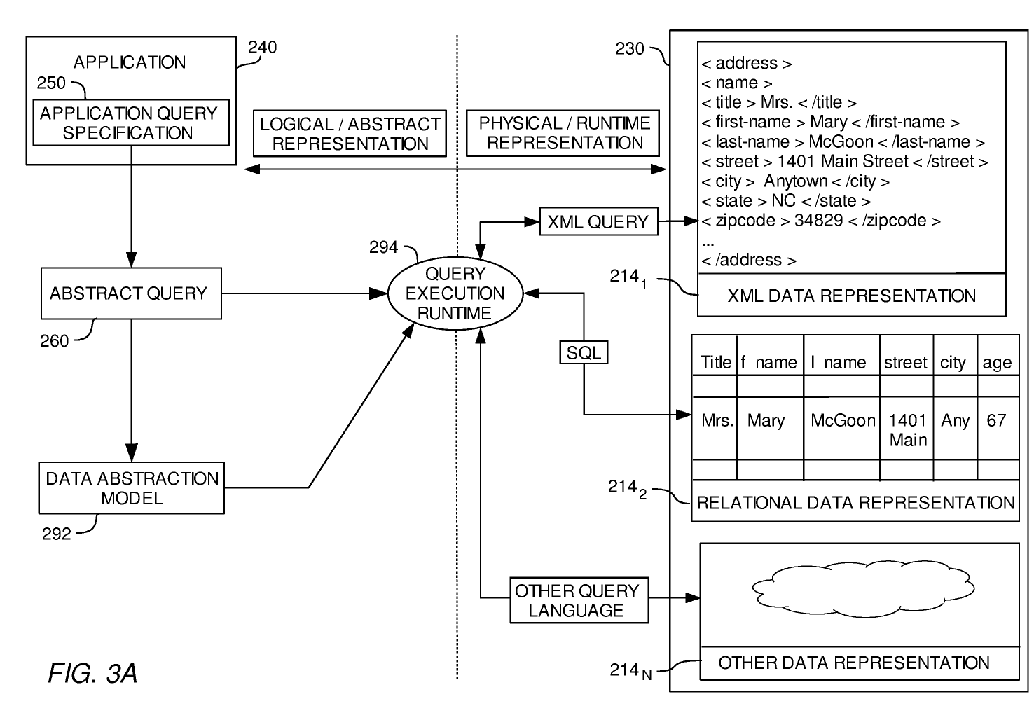

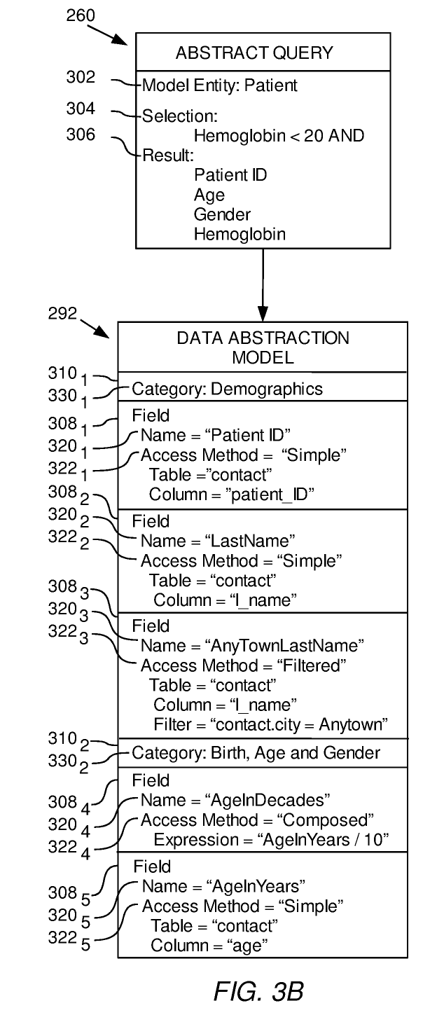

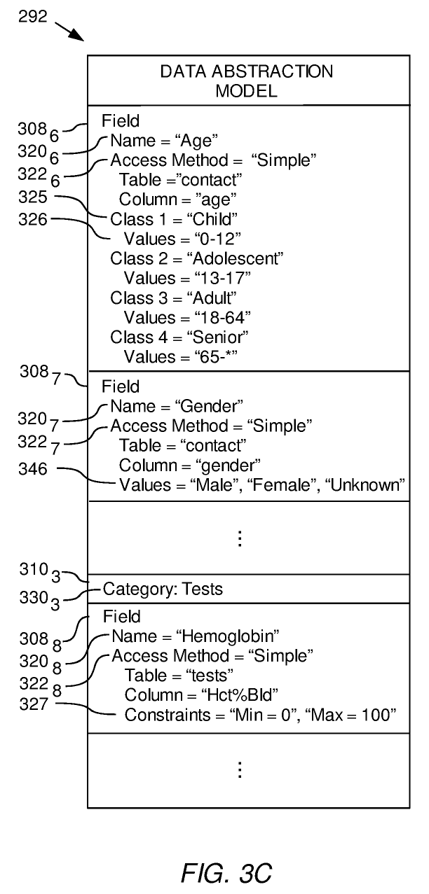

According to one aspect, the application 240 (and more generally, any requesting entity including, at the highest level, users) issues queries against the data 232 in the database 230. In general, the queries issued by the application 240 are defined according to an application query specification 250 and may be predefined (i.e., hard coded as part of the application 240) or generated in response to input (e.g., user input). The application query specification(s) 250 is further described below with reference to FIGS. 3-5.

Illustratively, the queries issued by the application 240 are created by users using the user interface 210, which can be any suitable user interface configured to create/submit queries. According to one aspect, the user interface 210 is a graphical user interface. However, it should be noted that the user interface 210 is only shown by way of example; any suitable requesting entity may create and submit queries against the database 230 (e.g., the application 240, an operating system or an end user). Accordingly, all such implementations are broadly contemplated.

In one embodiment, the requesting entity accesses a suitable database connectivity tool such as a Web application, an Open DataBase Connectivity (ODBC) driver, a Java® DataBase Connectivity (JDBC) driver or a Java® Application Programming Interface (Java® API) for creation of a query. A Web application is an application that is accessible by a Web browser and that provides some function beyond static display of information, for instance by allowing the requesting entity to query the database 230. An ODBC driver is a driver that provides a set of standard application programming interfaces to perform database functions such as connecting to the database 230, performing dynamic SQL functions, and committing or rolling back database transactions. A JDBC driver is a program included with a database management system (e.g., DBMS 220) to support JDBC standard access between the database 230 and Java® applications. A Java® API is a Java®-based interface that allows an application program (e.g., the requesting entity, the ODBC or the JDBC) that is written in a high-level language to use specific data or functions of an operating system or another program (e.g., the application 240).

In one embodiment, the queries issued by the application 240 are composed using the abstract model interface 290. Such queries are referred to herein as “abstract queries”. The abstract model interface 290 is further described below with reference to FIGS. 3-5. The abstract queries are transformed into a form consistent with the physical representation of the data 232 for execution against the database 230.

In the illustrated example, an abstract query 260 is created on the basis of logical fields defined by the data abstraction model 292. More specifically, the abstract query 260 is created by creating a results specification and, if required, selection criteria, as explained in more detail below with reference to FIGS. 3A-C. The results specification is defined by one or more result fields specifying what data elements should be returned from the database 230. The selection criteria is defined using one or more condition fields in corresponding query conditions that are configured to evaluate whether a given element of data should be returned. The result field(s) and the condition field(s) are defined using the logical fields of the data abstraction model 292.

In one embodiment, the abstract query 260 is translated by the runtime component 294 into a concrete (i.e., executable) query, such as an SQL or XML query. The executable query is submitted to the query execution unit 236 for execution. It should be noted that the query execution unit 236 illustratively only includes the query engine 234, for simplicity. However, the query execution unit 236 may include other components, such as a query parser and a query optimizer. A query parser is generally configured to accept a received query input from a requesting entity, such as the application(s) 240, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 230), an underlying system on which the search strategy will be executed (e.g., computer system 110 of FIG. 1), and/or optional user specified optimization goals. But not all strategies are equal and various factors may affect the choice of an optimum search strategy. However, in general such search strategies merely determine an optimized use of available hardware/software components to execute respective queries. The query optimizer may then forward the optimized executable query to the query engine 234 for execution. The optimized executable query is then executed by the query engine 234 against the data 232 of the database 230.

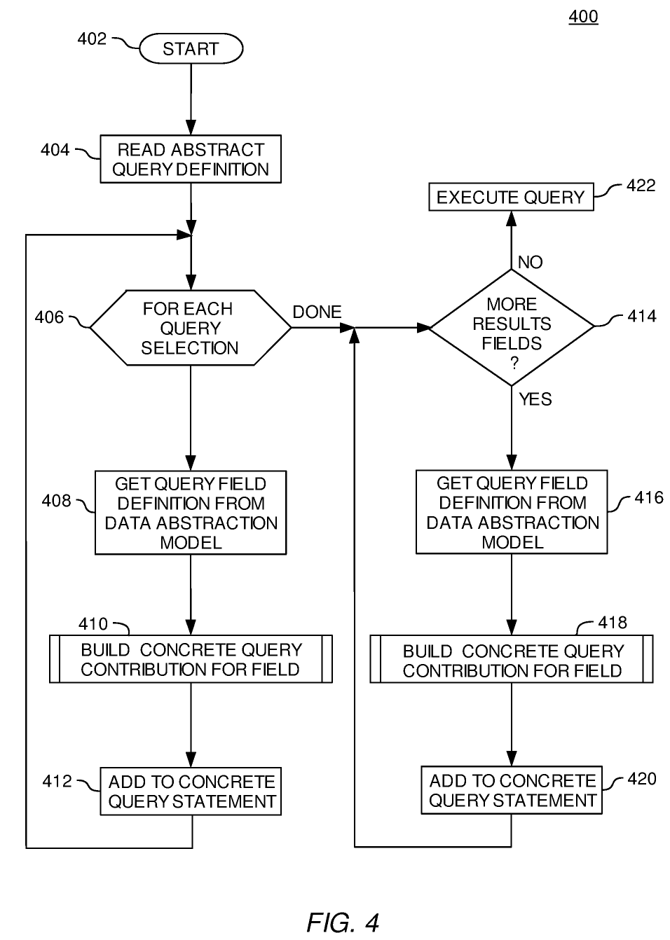

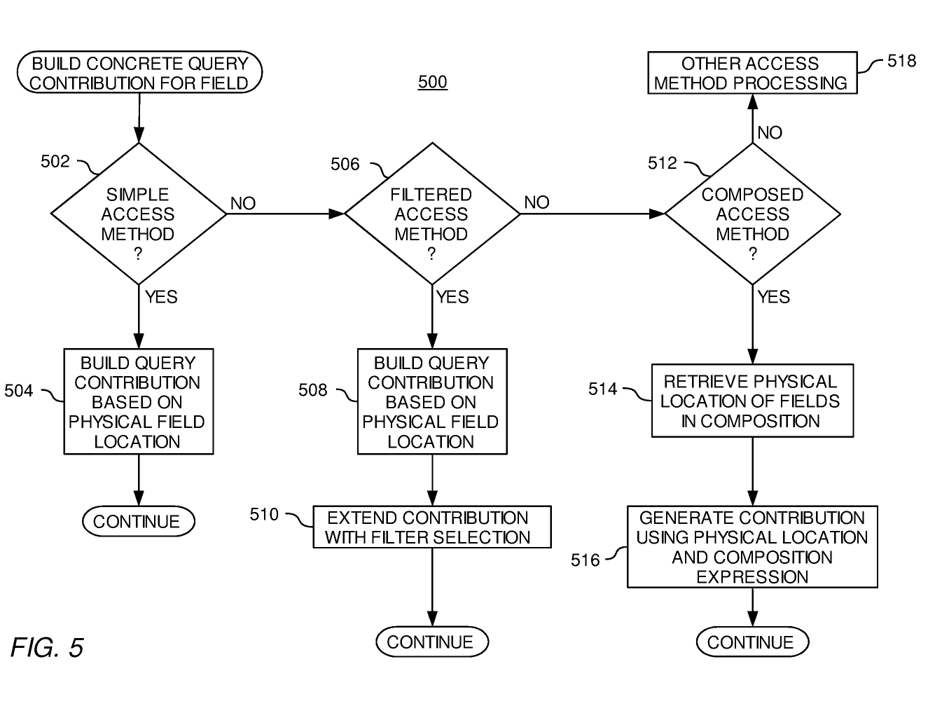

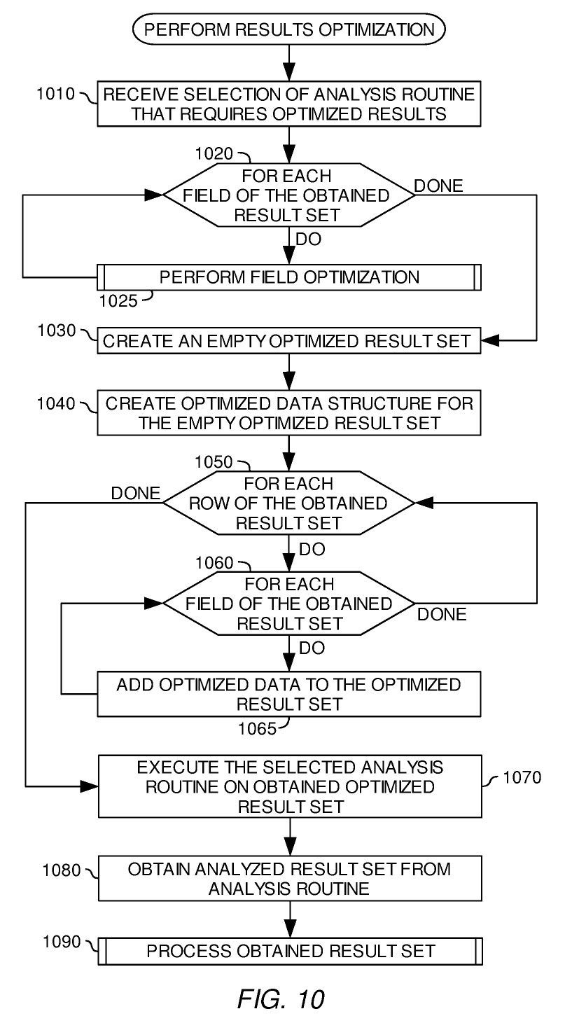

In one embodiment, the abstract query 260 is transformed into an executable query, as described above. An exemplary method for transforming an abstract query into an executable query is described in more detail below with reference to FIGS. 4-5. The executable query is then executed against the data 232 to determine a result set 280 having result data for the result fields of the abstract query 260. In one embodiment, the result data for the result fields is presented in non-binary form. The result set 280 having the non-binary result data is subsequently processed by the optimizer unit 270 to generate an optimized result set 282 that is presented in binary form. The optimized result set 282 in binary form can then be returned to the application(s) 240. An exemplary method for generating a binary result set using non-binary result data is described in more detail below with reference to FIG. 10.

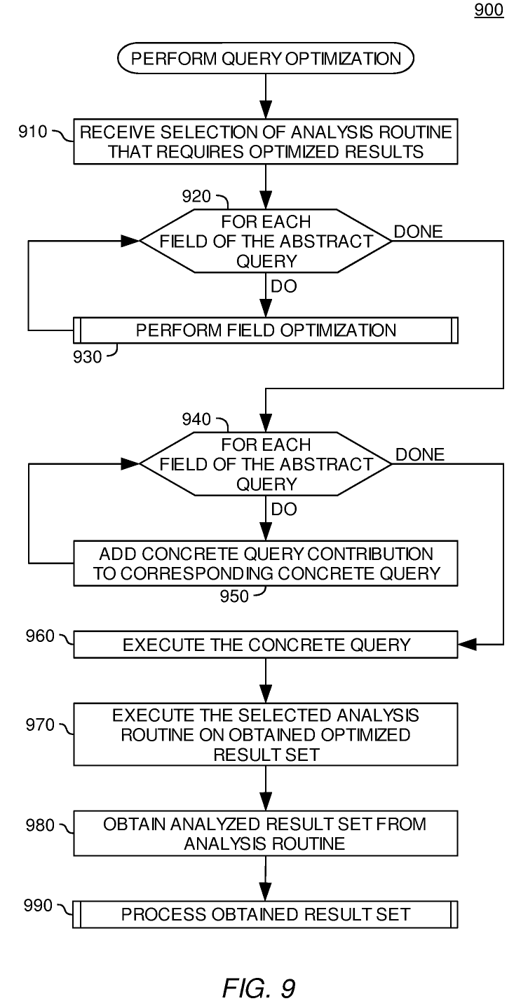

In one embodiment, the abstract query 260 is processed by the optimizer unit 270 prior to query execution in order to generate a modified abstract query 262. The modified abstract query 262 is configured to return binary result data. Accordingly, instead of executing the abstract query 260 against the database 230, the modified abstract query 262 is executed against the database 230 in order to generate the optimized result set 282 in binary form. An exemplary method for modifying an abstract query such that a binary result set is returned in response to execution of the modified abstract query is described in more detail below with reference to FIG. 9.

However, in one embodiment processing of the non-binary result set 280 and/or the abstract query 260 in order to obtain the optimized result set 282 in binary form is optional. For instance, obtaining the optimized result set 282 in binary form is only performed if a user issuing the abstract query 260 or processing the non-binary result set 280 requests it. However, in another embodiment, obtaining the optimized result set 282 in binary form may be performed automatically (irrespective of the user's explicit request) if the analysis routine(s) 284 requests a binary result set as input.

It should be noted that the optimizer unit 270 is merely described by way of example to illustrate a component which is suitable to implement aspects of the invention. In other words, the functions of the optimizer unit 270 can be implemented by other functional components. For instance, in one embodiment the functions of the optimizer unit 270 are implemented by the query engine 234 or a component which is implemented separate from the query execution unit 236. All such implementations are broadly contemplated.

In one embodiment, the optimized result set 282 in binary form is suitable as input to the analysis routine(s) 284. The analysis routine(s) 284 is configured to process the optimized result set 282 in order to create an analyzed result set 286 that conveys requested information to the requesting entity that issued the abstract query 260. For instance, the analyzed result set 286 may describe trends and/or patterns identified from the binary result set 282.

### Logical/Runtime View of Environment

FIGS. 3A-3C show an illustrative relational view of software components in one embodiment. According to one aspect, the software components are configured for query execution management and illustratively include the application 240, the data abstraction model 292, the runtime component 294 and the database 230 of FIG. 2. By way of example, the database 230 includes a plurality of exemplary physical data representations 214₁, 214₂, . . . 214_{N} for the data 232 of FIG. 2.

As noted above with reference to FIG. 2, the application 240 issues the abstract query 260 against the database 230. In one embodiment, the application 240 issues the query 260 as defined by the application query specification 250. The abstract query 260 is composed according to logical fields rather than by direct reference to underlying physical data entities in the database 230. The logical fields are defined by the data abstraction model 292 which generally exposes information as a set of logical fields that may be used within a query (e.g., the abstract query 260) issued by the application 240 to specify criteria for data selection and specify the form of result data returned from a query operation. Furthermore, the abstract query 260 may include a reference to an underlying model entity that specifies the focus for the abstract query 260 (model entity 302). In one embodiment, the application query specification 250 may include both criteria used for data selection (selection criteria 304) and an explicit specification of the fields to be returned (return data specification 306) based on the selection criteria 304, as illustrated in FIG. 3B.

The logical fields of the data abstraction model 292 are defined independently of the underlying data representation (i.e., one of the plurality of exemplary physical data representations 214_{1-N}) being used in the database 230, thereby allowing queries to be formed that are loosely coupled to the underlying data representation. More specifically, a logical field defines an abstract view of data whether as an individual data item or a data structure in the form of, for example, a database table. As a result, abstract queries such as the query 260 may be defined that are independent of the particular underlying data representation used. Such abstract queries can be transformed into a form consistent with the underlying physical data representation 214_{1-N} for execution against the database 230. By way of example, the abstract query 260 is translated by the runtime component 294 into an executable query which is executed against the database 230 to determine a corresponding result set (e.g., result set 280 and/or optimized result set 282 of FIG. 2) for the abstract query 260.

In one embodiment, illustrated in FIGS. 3B-C, the data abstraction model 292 comprises a plurality of field specifications 308₁, 308₂, 308₃, 308₄, 308₅, 308₆, 308₇ and 308₈ (eight shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅, 320₆, 320₇, 320₈ (collectively, field name 320) and an associated access method attribute 322₁, 322₂, 322₃, 322₄, 322₅, 322₆, 322₇, 322₈ (collectively, access methods 322). Each attribute may have a value. For example, logical field name attribute 320₁ has the value “Patient ID” and access method attribute 322₁ has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “contact” and data location metadata “Column” has the value “patient_ID”. Accordingly, assuming an underlying relational database schema in the present example, the values of data location metadata “Table” and “Column” point to a table “contact” having a column “patient_ID”.

In one embodiment, each field specification 308 may contain a definition of one or more value constraints that define allowable values for the respective logical field. By way of example, the field specifications 308₆ to 308₈ include an exemplary classification definition, an exemplary list definition and an exemplary limitation definition, respectively.

Illustratively, the field specification 3086 includes a classification definition that defines four different value classes “Class 1” to “Class 4” for allowable age values. By way of example, age values from “0” to “12” as defined by a value range parameter 326 are associated with a value class 325 “Class 1” that is referred to as the “Child” class. Age values from “13” to “17” are illustratively associated with the value class “Class 2” that is referred to as the “Adolescent” class, age values from “18” to “64” with the value class “Class 3” that is referred to as the “Adult” class, and age values greater or equal than “65” with the value class “Class 4” that is referred to as the “Senior” class.

The field specification 308₇ illustratively includes a list definition 346 that enumerates allowable values for associated gender data. By way of example, the list definition 346 defines “Male”, “Female” and “Unknown” as allowable values for data that is associated with the “Gender” field 308₇.

The field specification 308₈ illustratively includes a limitation definition 327 that defines an allowable range of values for associated Hemoglobin values. By way of example, the limitation definition 327 defines “0” as minimum allowable value for data that is associated with the “Hemoglobin” field 308₈ and “100” as maximum allowable value.

It should be noted that the illustrated value constraint definitions are merely illustrative and not limiting of the invention. For instance, the illustrated value constraint definitions can be adapted to user- and/or application-specific requirements. By way of example, a user may define an upper and a lower limit of normal for the limitation definition 327 of the Hemoglobin test values for execution of a given query. More specifically, the user may input corresponding upper and/or lower limits of normal lying within the defined minimum and maximum allowable values prior to query execution to customize the limitation definition 327. For instance, assume that the user defines for the Hemoglobin test values a lower limit of normal as “15” and an upper limit as “25”. Thus, all Hemoglobin test values of a corresponding query result returned in execution of the given query lying inside the lower and upper limits of normal could be considered as “normal” values. Such “normal” values can be represented in a corresponding binary result set (e.g., optimized result set 282 of FIG. 2) using the binary value “1”, while all values lying outside the upper and lower limits of normal can be represented using a binary “0” or null value. Alternatively, values below the lower limit of normal could be considered as “low” and values above the upper limit of normal could be considered as “high”, while values lying inside the lower and upper limits of normal could be considered as “normal”. In this case, “low” values can be represented in a subcolumn “LOW” of the corresponding binary result set using the binary value “1”. Similarly, “high” values can be represented in a subcolumn “HIGH” and “normal” values in a subcolumn “NORMAL” of the corresponding binary result set using the binary value “1”, respectively. Accordingly, all such possible implementations as well as any possible value constraint definitions are broadly contemplated.

In one embodiment, groups (i.e. two or more) of logical fields may be part of categories. Accordingly, the data abstraction model 292 includes a plurality of category specifications 310₁, 310₂ and 310₃ (three shown by way of example), collectively referred to as the category specifications. In one embodiment, a category specification is provided for each logical grouping of two or more logical fields. For example, logical fields 308₁₋₃, 308₄₋₇ and 308₈ are part of the category specifications 310₁, 310₂ and 310₃, respectively. A category specification is also referred to herein simply as a “category”. The categories are distinguished according to a category name, e.g., category names 330₁, 330₂ and 330₃ (collectively, category name(s) 330). In the present illustration, the logical fields 308₁₋₃ are part of the “Demographics” category, logical fields 308₄₋₇ are part of the “Birth, Age and Gender” category and logical field 308₈ is part of the “Tests” category.

The access methods 322 generally associate (i.e., map) the logical field names to data in the database (e.g., database 230 of FIG. 2). As illustrated in FIG. 3A, the access methods associate the logical field names to a particular physical data representation 214_{1-N} in the database. By way of illustration, two data representations are shown, an XML data representation 214₁ and a relational data representation 2142. However, the physical data representation 214_{N} indicates that any other data representation, known or unknown, is contemplated. In one embodiment, a single data abstraction model 292 contains field specifications (with associated access methods) for two or more physical data representations 214_{1-N}. In an alternative embodiment, a different single data abstraction model 292 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂ and 308₅₋₈ exemplify simple field access methods 322₁, 322₂, and 322₅₋₈, respectively. Simple fields are mapped directly to a particular entity in the underlying physical representation (e.g., a field mapped to a given database table and column). By way of illustration, as described above, the simple field access method 322₁ shown in FIG. 3B maps the logical field name 320₁ (“Patient ID”) to a column named “patient_ID” in a table named “contact”.

The field specification 308₃ exemplifies a filtered field access method 322₃. Filtered fields identify an associated physical entity and provide filters used to define a particular subset of items within the physical representation. An example is provided in FIG. 3B in which the filtered field access method 322₃ maps the logical field name 320₃ (“AnyTownLastName”) to a physical entity in a column named “I_name” in a table named “contact” and defines a filter for individuals in the city of “Anytown”. Another example of a filtered field is a New York ZIP code field that maps to the physical representation of ZIP codes and restricts the data only to those ZIP codes defined for the state of New York.

The field specification 308₄ exemplifies a composed field access method 322₄. Composed access methods compute a logical field from one or more physical fields using an expression supplied as part of the access method definition. In this way, information which does not exist in the underlying physical data representation may be computed. In the example illustrated in FIG. 3B the composed field access method 322₄ maps the logical field name 320₄ “AgeInDecades” to “AgeInYears/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 292 shown in FIG. 3B are representative of logical fields mapped to data represented in the relational data representation 214₂ shown in FIG. 3A. However, other instances of the data abstraction model 292 map logical fields to other physical representations, such as XML.

An illustrative abstract query corresponding to the abstract query 260 shown in FIG. 3B is shown in Table I below. By way of illustration, the illustrative abstract query is defined using XML. However, any other language may be used to advantage.

TABLE I
ABSTRACT QUERY EXAMPLE

001 <?xml version=“1.0”?>
002 <!--Query string representation: (Hemoglobin <“20”-->
003 <QueryAbstraction>
004 <Selection>
005 <Condition internalID=“4”>
006 <Condition field=“Hemoglobin” operator=“LT” value=“20”
007 internalID=“1”/>
008 </Selection>
009 <Results>
010 <Field name=“Patient ID”/>
011 <Field name=“Age”/>
012 <Field name=“Gender”/>
013 <Field name=“Hemoglobin”/>
014 </Results>
015 <Entity name=“Patient” >
016 <EntityField required=“Hard” >
017 <FieldRef name=“data://Demographics/Patient ID” />
018 <Usage type=“query” />
019 </EntityField>
020 </Entity>
021 </QueryAbstraction>

Illustratively, the abstract query shown in Table I includes a selection specification (lines 004-008) containing selection criteria and a results specification (lines 009-014). In one embodiment, a selection criterion consists of a field name (for a logical field), a comparison operator (=, >, <, etc) and a value expression (what is the field being compared to). In one embodiment, a results specification is a list of abstract result fields that are to be returned as a result of query execution. A results specification in the abstract query may consist of a field name and sort criteria. The abstract query shown in Table I further includes a model entity specification in lines 015-020 which specifies that the query is a query of the “patient” model entity.

An illustrative data abstraction model (DAM) corresponding to the data abstraction model 292 shown in FIGS. 3B-C is shown in Table II below. By way of illustration, the illustrative Data Abstraction Model is defined using XML. However, any other language may be used to advantage.

TABLE II
DATA ABSTRACTION MODEL EXAMPLE

001 <?xml version=“1.0”?>
002 <DataAbstraction>
003 <Category name=“Demographics”>
004 <Field queryable=“Yes” name=“Patient ID” displayable=“Yes”>
005 <AccessMethod>
006 <Simple columnName=“patient_ID ” tableName=“contact”></Simple>
007 </AccessMethod>
008 </Field>
009 <Field queryable=“Yes” name=“LastName” displayable=“Yes”>
010 <AccessMethod>
011 <Simple columnName=“I_name” tableName=“contact”></Simple>
012 </AccessMethod>
013 </Field>
014 <Field queryable=“Yes” name=“AnyTownLastName” displayable=“Yes”>
015 <AccessMethod>
016 <Filter columnName=“I_name” tableName=“contact”
017 Filter=”contact.city=Anytown”> </Filter>
018 </AccessMethod>
019 </Field>
020 </Category>
021 <Category name=“Birth, Age and Gender”>
022 <Field queryable=“Yes” name=“AgeInDecades” displayable=“Yes”>
023 <AccessMethod>
024 <Composed
025 Expression=”field:AgeInYears/10”> </Composed>
026 </AccessMethod>
027 </Field>
028 <Field queryable=“Yes” name=“AgeInYears” displayable=“Yes”>
029 <AccessMethod>
030 <Simple columnName=“age” tableName=“contact”></Simple>
031 </AccessMethod>
032 </Field>
033 <Field queryable=“Yes” name=“Age” displayable=“Yes”>
034 <AccessMethod>
035 <Simple columnName=“age” tableName=“contact”></Simple>
036 </AccessMethod>
037 <Class name=”Child”>
038 <Value min=“0” max=“12” />
039 </Class>
040 <Class name=”Adolescent”>
041 <Value min=“13” max=“17” />
042 </Class>
043 <Class name=”Adult”>
044 <Value min=“18” max=“64” />
045 </Class>
046 <Class name=”Senior”>
047 <Value min=“65” />
048 </Class>
049 </Field>
050 <Field queryable=“Yes” name=“Gender” displayable=“Yes”>
051 <AccessMethod>
052 <Simple columnName=“gender” tableName=“contact”></Simple>
053 </AccessMethod>
054 <List>
055 <Value actualVal=“F” val=“Female” />
056 <Value actualVal=“M” val=“Male” />
057 <Value actualVal=“U” val=“Unknown” />
058 </List>
059 </Field>
060 </Category>
061 <Category name=“Tests”>
062 <Field queryable=“Yes” name=“Hemoglobin” displayable=“Yes”>
063 <AccessMethod>
064 <Simple columnName=“Hct%BId” tableName=“tests”></Simple>
065 </AccessMethod>
066 <Lowerlimit val=“0” />
067 <Upperlimit val=“100” />
068 </Field>
069 </Category>
070 </DataAbstraction>

By way of example, note that lines 004-008 correspond to the first field specification 308₁ of the DAM 292 shown in FIG. 3B and lines 009-013 correspond to the second field specification 308₂. Note further that lines 033-049 correspond to the field specification 308₆ of the DAM 292 shown in FIG. 3C, wherein lines 037-039 represent the value class definition 325 of the “Child” class with the associated value range parameter 326. Furthermore, lines 050-059 correspond to the field specification 308₇ of the DAM 292 shown in FIG. 3C, wherein lines 054-058 represent the list definition 346, and lines 062-068 correspond to the field specification 308₈ of the DAM 292, wherein lines 066-067 represent the limitation definition 327.

As was noted above, an executable query can be generated on the basis of the abstract query of Table I for execution against an underlying database (e.g., database 230 of FIG. 3A). An exemplary method for generating an executable query on the basis of an abstract query is described below with reference to FIGS. 4-5. Another exemplary method for generating an executable query from an abstract query is described in commonly assigned, co-pending, U.S. patent application Ser. No. 11/005,418, filed Dec. 6, 2004, entitled “ABSTRACT QUERY PLAN”, which is incorporated herein in its entirety.

### Generating an Executable Query from an Abstract Query

Referring now to FIG. 4, an illustrative runtime method 400 exemplifying one embodiment of generating an executable query (also referred to hereinafter as “concrete” query) on the basis of an abstract query (e.g., abstract query 260 of FIG. 2) using the runtime component 294 of FIG. 2 is shown. The method 400 is entered at step 402 when the runtime component 294 receives the abstract query (such as the abstract query shown in Table I) as input. At step 404, the runtime component 294 reads and parses the abstract query and locates individual selection criteria (e.g., selection criteria 304 of FIG. 3B) and desired result fields (e.g., return data specification 306 of FIG. 3B).

At step 406, the runtime component 294 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 294 uses the field name from a selection criterion of the abstract query to look up the definition of the field in the data abstraction model 292. As noted above, the field definition includes a definition of the access method used to access the data structure associated with the field. The runtime component 294 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 230 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

After building the data selection portion of the concrete query, the runtime component 294 identifies the information to be returned as a result of query execution. As described above, in one embodiment, the abstract query defines a list of result fields, i.e., a list of logical fields that are to be returned as a result of query execution, referred to herein as a results specification. A results specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 294 looks up a result field name (from the result specification of the abstract query) in the data abstraction model 292 and then retrieves a result field definition from the data abstraction model 292 to identify the physical location of data to be returned for the current logical result field. The runtime component 294 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 422, where the concrete query is executed.

One embodiment of a method 500 for building a concrete query contribution for a logical field according to steps 410 and 418 is described with reference to FIG. 5. At step 502, the method 500 queries whether the access method associated with the current logical field is a simple access method. If so, the concrete query contribution is built (step 504) based on physical data location information and processing then continues according to method 400 as described above. Otherwise, processing continues to step 506 to query whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### Managing Processing of a Query and a Query Result

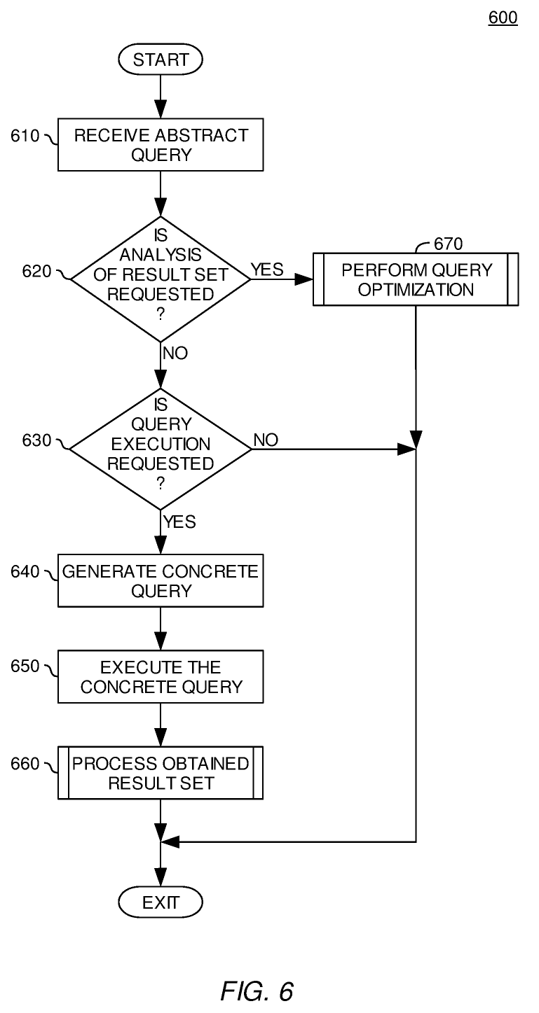

Referring now to FIG. 6, one embodiment of a method 600 for processing of a query (e.g., abstract query 260 of FIG. 2) and/or a corresponding result set (e.g., result set 280 of FIG. 2) is illustrated. At least a portion of the steps of method 600 can be performed using the user interface 210, the abstract model interface 290, the optimizer unit 270 and/or the query execution unit 236 of FIG. 2.

Method 600 starts at step 610, where an abstract query is received from a requesting entity (e.g., the application(s) 240 of FIG. 2). The abstract query is issued against one or more underlying databases (e.g., database 230 of FIG. 2) to obtain a corresponding result set. Assume now that the exemplary abstract query of Table III below is received. Assume further that the exemplary abstract query of Table III is issued by a user using the user interface 210 of FIG. 2. For simplicity, the exemplary abstract query shown in Table III is defined in natural language.

TABLE III
ABSTRACT QUERY EXAMPLE

001 FIND
002 Patient ID, Age, Gender, Hemoglobin
003 WHERE
004 Hemoglobin < ’20’

The exemplary abstract query of Table III includes four result fields (line 002) and is configured to retrieve age values (“Age” in line 002), gender information (“Gender” in line 002) and Hemoglobin test values (“Hemoglobin” in line 002) for patients of a medical institution. Each patient is uniquely identified by an associated patient identifier (“Patient ID” in line 002). The exemplary abstract query of Table III further includes a query condition (lines 004) that restricts returned data to data of patients having a Hemoglobin test value that is less than “20”.

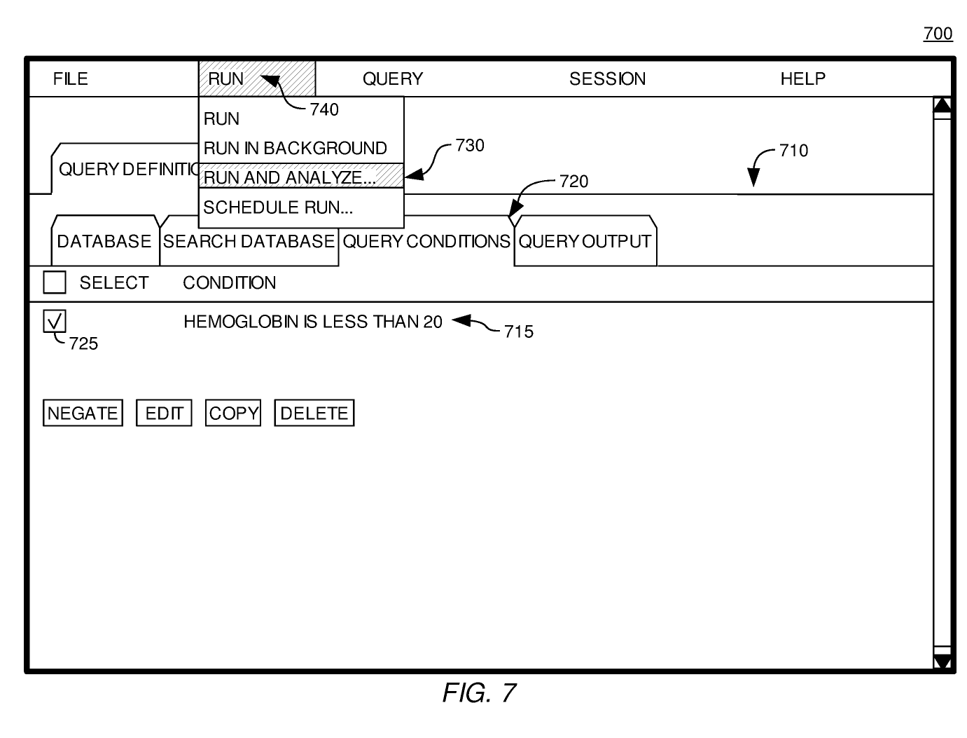

At step 620, it is determined whether analysis of the corresponding result set obtained in response to execution of the abstract query is requested. More specifically, it is determined whether it is requested to process the result set using an analysis routine (e.g., analysis routine(s) 284 of FIG. 2) that requires a binary result set as input. In one embodiment, such a request can be issued by the requesting entity. For instance, assume that in the given example the user accesses a GUI screen displayed by the user interface 210 of FIG. 2 to indicate such a request. An exemplary GUI screen is described in more detail below with reference to FIG. 7.

Referring now to FIG. 7, one embodiment of an exemplary GUI screen 700 for creating an abstract query and requesting processing of an obtained result set using a suitable analysis routine is illustrated. The exemplary GUI screen 700 illustratively includes a display area 710 for creation of an abstract query that includes a plurality of displayable panels.

Illustratively, a panel 720 is displayed for definition of one or more query conditions. By way of example, a query condition 715 “Hemoglobin is less than 20” is displayed (e.g., the query condition in line 004 of Table III) in the panel 720. The query condition 715 is selected as query condition for the abstract query (e.g., the exemplary abstract query of Table III) by clicking an associated checkbox 720.

Using a drop down menu 740 “Run”, a requested processing type can be selected for the abstract query. Illustratively, a menu entry 730 “Run and Analyze” is selected from the menu 740. In the given example, the menu entry 730 is configured to issue a request for execution of the abstract query against the underlying database(s) and subsequent processing of an obtained result set using a requested analysis routine.

By way of example, assume that the GUI screen 700 displays upon selection of the menu entry 730 a graphical selection element to the user that allows selection of the requested analysis routine. The graphical selection element can alternatively be displayed after query execution, when the obtained result set is displayed to the user. All such implementations are broadly contemplated.

Assume that in the given example the user requests analysis of the corresponding result set by selecting the menu entry 730 “Run and Analyze” of the exemplary GUI screen of FIG. 7. Accordingly, referring now back to FIG. 6, it is determined at step 620 that analysis of the corresponding result set is requested and processing proceeds with step 670, where a process for optimization of the abstract query is performed. An exemplary process for query optimization is described in more detail below with reference to FIG. 9. Method 600 then exits.

If, however, analysis of the corresponding result set using a requested analysis routine is not requested as described above, processing proceeds with step 630. At step 630, it is determined whether execution of the abstract query is requested without subsequent analysis of the corresponding result set. If so, method 600 proceeds with step 640. Otherwise, method 600 exits.

In one embodiment, query execution without subsequent analysis of the corresponding result set can be requested by the requesting entity. For instance, in the given example the user may select a menu entry “Run” which is selectable in the drop down menu 740 displayed in the exemplary GUI screen 700 of FIG. 7 to request execution of the created abstract query without subsequent analysis of the obtained result set. However, it should be noted that using the exemplary GUI screen for indicating a requested processing type for the abstract query and the corresponding result set is merely described by way of example. Alternative implementations are possible. For instance, the processing type can be derived from user-specific settings and/or metadata associated with the abstract query. All such implementations are broadly contemplated.

At step 640, the abstract query is transformed into a concrete query that is executable against the underlying database(s). In one embodiment, transformation of the abstract query into the concrete query is performed as described above with reference to FIGS. 4-5. However, for brevity the obtained concrete query is not described in more detail.

At step 650, the concrete query is executed against the underlying database(s), whereby non-binary result data defining the corresponding result set is retrieved. By way of example, assume that the exemplary result set of Table IV below is obtained if the exemplary abstract query of Table III is transformed into a corresponding concrete query and executed against a given database. Assume further that the exemplary result set of Table IV is obtained from a database table “contact” having information for the “Patient ID”, “Age” and “Gender” result fields, and a database table “tests” having Hemoglobin test values for the “Hemoglobin” result field (line 002 of Table III). In one embodiment, the database tables are identified using a corresponding data abstraction model (e.g., the exemplary data abstraction model of Table II) used for transforming the abstract query into the corresponding concrete query, as described above with reference to FIGS. 4 and 5.

TABLE IV
RESULT SET EXAMPLE

| | Patient ID | Age | Gender | Hemoglobin |
|---|---|---|---|---|
| 001 | | | | |
| 002 | 1 | 14 | Female | 19.5 |
| 003 | 2 | 35 | Male | 22 |
| 004 | 3 | 66 | Female | 7 |
| 005 | 4 | 78 | Male | 10 |
| 006 | 5 | 6 | Female | 23 |

The exemplary result set of Table IV includes four result fields (line 001) having information concerning patients of a given hospital. More specifically, the exemplary result set of Table IV illustratively includes data records having patient identifiers (“Patient ID” result field), age (“Age” result field), gender (“Gender” result field) and Hemoglobin test values (“Hemoglobin” result field) of selected patients having Hemoglobin test values that are less than “20” (line 004 of the exemplary abstract query of Table III).

It should be noted that the exemplary result set of Table IV includes the non-binary result data, i.e., result data that is presented in non-binary form. In other words, the result data included with the exemplary result set of Table IV is more dimensional and does not only consist of the binary values “1” and “0” (or null).

At step 660, the obtained result set is processed. Method 600 then exits.

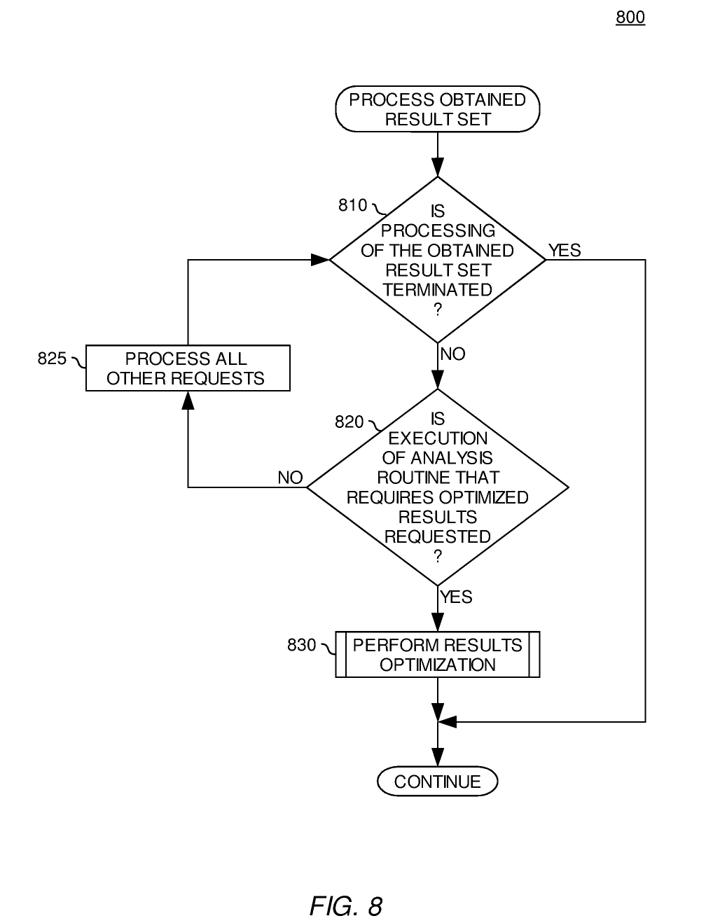

One embodiment of a method 800 for processing an obtained result set according to step 660 of method 600 is described with reference to FIG. 8. Method 800 starts at step 810, where it is determined whether processing of the obtained result set is terminated. For instance, processing of the obtained result set is considered to be terminated if an underlying database session was terminated by the user or if the obtained result set was closed by the user. If so, processing returns to the method 600 of FIG. 6. Otherwise, processing proceeds with step 820.

At step 820, it is determined whether analysis of the obtained result set using an analysis routine (e.g., analysis routine(s) 284 of FIG. 2) that requires a binary result set as input is requested. As noted above, such a request can be issued in one embodiment by the requesting entity. For instance, in the given example the user may select a menu entry “Analyze” which can be selectable in a drop down menu of a corresponding GUI screen that displays the obtained result set. The menu entry “Analyze” can be configured to request analysis of the displayed result set using a requested analysis routine that requires a binary result set as input.

If the determination at step 820 is affirmative, processing proceeds with step 830. Otherwise, processing proceeds with step 825.

At step 825, any requests related to the obtained result set are processed. For instance, assume that sorting, graphing and/or saving of the obtained result set are requested. Accordingly, the obtained result set is sorted, graphed and then persistently stored. Processing then returns to step 810.

At step 830, the obtained result set is processed to generate a binary result set from the non-binary result data (e.g., the exemplary non-binary result data in Table IV) included with the obtained result set. An exemplary method of generating a binary result set from a result set having non-binary result data is described in more detail below with reference to FIG. 10. Processing then returns to the method 600 of FIG. 6.

### Query Optimization

One embodiment of a method 900 for optimizing an abstract query (e.g., abstract query 260 of FIG. 2) according to step 670 of method 600 of FIG. 6 is now described with reference to FIG. 9. More specifically, the abstract query is optimized such that a modified abstract query (e.g., modified abstract query 262 of FIG. 2) is generated that is configured to produce a binary result set (e.g., optimized result set 282 of FIG. 2).

Method 900 starts at step 910, where an analysis routine (e.g., analysis routine 284 of FIG. 2) that requires a binary result set as input is selected. As noted above, the analysis routine can be selected using a suitable GUI screen displayed by the user interface 210 of FIG. 2. In one embodiment, the selected analysis routine may include a suitable attribute, such as “binaryResults”, that is used to indicate that the routine requires a binary result set as input. More specifically, assume that in the given example the selected analysis routine includes a “binaryResults” attribute that is set to “Yes” in order to indicate that the analysis routine requires a binary result set as input. The selected analysis routine may further include an attribute, such as “allowStreamResults”, that is used to indicate whether data obtained in response to query execution can be streamed as input to the analysis routine or whether only pre-stored result sets are accepted. Thus, where the selected analysis routine includes a “binaryResults” attribute that is set to “Yes” but includes no “allowStreamResults”, or where the “allowStreamResults” attribute is set to “No”, the selected analysis routine will only accept pre-stored result sets and not streamed data. In the given example, assume that the selected analysis routine includes an “allowStreamResults” attribute that is set to “Yes” in order to indicate that result data obtained in response to execution of a query (e.g., abstract query 260 of FIG. 2) against an underlying database (e.g., database 230 of FIG. 2) is streamed as input to the analysis routine. However, as analysis routines and selection thereof is well-known in the art, the selected analysis routine is not described in more detail, for brevity.

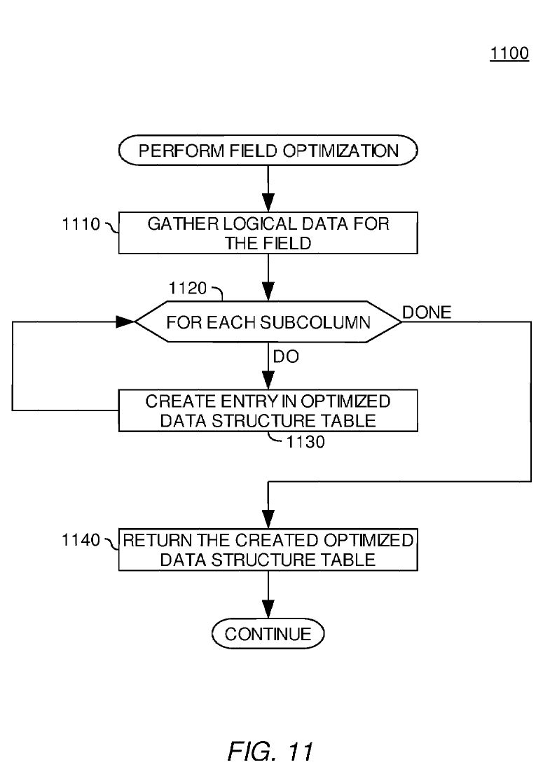

At step 920, a loop consisting of steps 920 and 930 is entered for each result field (e.g., the result fields in line 002 of the exemplary abstract query of Table III) of the abstract query. At step 930, a process for determining optimization data for the result field is performed. To this end, an underlying data abstraction model (e.g., data abstraction model 292 of FIG. 2) having a logical field that defines the result field is accessed. If the logical field includes one or more value constraints that can be used for the generation of binary result data, the value constraint(s) are retrieved and corresponding optimization data is determined. An exemplary method for determining optimization data for result fields is described below with reference to FIG. 11.

Using the determined optimization data, an optimized data structure table is generated. By way of example, assume that in the given example the exemplary optimized data structure table of Table V below is created for the exemplary abstract query of Table III above.

TABLE V
EXEMPLARY OPTIMIZED DATA STRUCTURE TABLE

| | Field | Subcolumn | Value Condition |
|---|---|---|---|
| 001 | | | |
| 002 | Patient ID | None | None |
| 003 | Age | Child | value in range 0–12 |
| 004 | Age | Adolescent | value in range 13–17 |
| 005 | Age | Adult | value in range 28–64 |
| 006 | Age | Senior | value >=65 |
| 007 | Age | Missing | value is null |
| 008 | Age | Invalid | value <0 |
| 009 | Gender | Male | value = Male |
| 010 | Gender | Female | value = Female |
| 011 | Gender | Unknown | value = Unknown |
| 012 | Gender | Missing | value is null |
| 013 | Gender | Invalid | value not in (Male, Female, |
| | | | Unknown) |
| 014 | Hemoglobin | Low | value <15 |
| 015 | Hemoglobin | Normal | value >=15 and value <=25 |
| 016 | Hemoglobin | High | value >25 |
| 017 | Hemoglobin | Missing | value is null |
| 018 | Hemoglobin | Invalid | value <0 OR value >100 |

As can be seen from Table V, the exemplary optimized data structure table includes at least one row having optimization data for each of the result fields of the abstract query of Table III above. The optimization data defines rules for generating binary result data from non-binary result data. More specifically, line 002 indicates that the “Patient ID” field (line 002 of Table II) of the underlying data abstraction model does not include value constraints that can be used as optimization data for the generation of binary result data for the “Patient ID” field. Lines 003-008 indicate generated optimization data for the “Age” field (line 002 of Table III), lines 009-013 for the “Gender” field (line 002 of Table III) and lines 014-018 for the “Hemoglobin” field (line 002 of Table III). By way of example, line 003 indicates that an “Age” column created for the “Age” result field (line 002 of Table III) in a corresponding binary result set can be augmented with a subcolumn “Child”. In one embodiment, the binary value “1” can thus be entered into the “Child” subcolumn for each returned age value from “0” to “12”.

As noted above, in one embodiment each row in the generated optimized data structure table is created on the basis of one or more value constraints retrieved from a logical field of the underlying data abstraction model. Assume now that in the given example the value constraints described above with reference to FIG. 3C and Table II exist for the logical fields that correspond to the “Age”, “Gender” and “Hemoglobin” result fields (line 002 of Table III) of the exemplary abstract query of Table Ill. Note, however, that no value constraints are defined for the “Patient ID” field (lines 004-008 of Table II) of the underlying data abstraction model of Table II. Thus, no optimization data is generated in the exemplary optimized data structure table of Table V for the “Patient ID” field, as noted above.

In the given example, the exemplary value constraints of Table VI below which are described in natural language, for simplicity, are retrieved for the “Age” result field from lines 037-048 of Table II. Furthermore, the exemplary value constraints of Table VII are retrieved for the “Gender” result field from lines 054-058 of Table II, and the exemplary value constraints of Table VII are retrieved for the “Hemoglobin” result field from lines 066-067 of Table II, both of which are also described in natural language, for simplicity.

TABLE VI
CLASSIFICATION DEFINITION EXAMPLE

| | | |
|---|---|---|
| 001 | Child | 0–12 |
| 002 | Adolescent | 13–17 |
| 003 | Adult | 18–64 |
| 004 | Senior | 65–* |

As noted above with reference to FIG. 3C, allowable age values for the “Child” class are values from “0” to “12” (line 001), for the “Adolescent” class from “13” to “17” (line 002), for the “Adult” class from “18” to “64” (line 003) and for the “Senior” class equal or greater than “65” (line 004).

Note that the optimization data in lines 003-006 of Table V corresponds to the value constraints in lines 001-004 of Table VI. The optimization data in lines 007-008 of Table V is, however, automatically generated on the basis of the value constraints of Table VI, in one embodiment. More specifically, the value constraints of Table VI do not specify a maximum allowed age value as any value equal or greater than “65” is associated with the “Senior” class. Accordingly, the exemplary optimized data structure table of Table V does not include optimization data related to a maximum allowed age value. However, the value constraints of Table VI specify a minimum allowed age value which is the value “0” of the “Child” class, as values below “0” are not associated with any of the defined age classes. Thus, it can be determined that age values below “0” are not allowed and, therefore, invalid. Accordingly, the optimization data in line 008 of the exemplary optimized data structure table of Table V can be generated. Furthermore, it is considered that for an “Age” field without any age value (i.e., a null value) the corresponding value is missing and accordingly the optimization data in line 007 of the exemplary optimized data structure table of Table V can be generated.

TABLE VII
LIST DEFINITION EXAMPLE

| | |
|---|---|
| 001 | Male |
| 002 | Female |
| 003 | Unknown |

As noted above with reference to FIG. 3C, allowable gender values are “Male” (line 001), “Female” (line 002) and “Unknown” (line 003). Note that the optimization data in lines 009-011 of Table V corresponds to the value constraints in lines 001-003 of Table VII. The optimization data in lines 012-013 of Table V is generated similar to the optimization data in lines 007-008 of Table V, as described above.

TABLE VIII
LIMITATION DEFINITION EXAMPLE

| | | |
|---|---|---|
| 001 | Minimum | 0 |
| 002 | LLN | 15 |
| 003 | ULN | 25 |
| 004 | Maximum | 100 |

As noted above with reference to FIG. 3C, allowable Hemoglobin values are greater or equal than “0” (line 001) and equal or less than “100” (line 002). Assume further that the value “15” was defined as lower limit of normal and “25” as upper limit of normal for the “Hemoglobin” field, as noted above. Note that the optimization data in lines 014-016 and 018 of Table V corresponds to the value constraints in lines 001-004 of Table VIII. Specifically, note that the optimization data in line 016 of Table V corresponds to the value constraints in lines 001 and 004 of Table VIII. The optimization data in line 017 of Table V is generated similar to the optimization data in lines 007-008 of Table VI, as described above.

Once each of the result fields of the abstract query was processed by the loop consisting of steps 920-930, processing continues at step 940, where a loop consisting of steps 940 and 950 is entered for each of the result fields. The loop is configured to generate a concrete query that is configured to return a binary result set from one or more underlying databases (e.g., database 230 of FIG. 2). To this end, at step 950 a concrete query contribution for the result field is added to a concrete query that is created for the abstract query using the generated optimized data structure table. More specifically, a concrete query contribution for the result field is added to the concrete query for each row in the generated optimized data structure table.

In one embodiment, the loop consisting of steps 940-950 is performed on a concrete query that is created from the abstract query as explained above with reference to FIGS. 4-5. Accordingly, only result fields in the concrete query for which optimization data is retrieved in the loop consisting of steps 920-930 need to be modified. In another embodiment, the abstract query is modified on the basis of the retrieved optimization data. Thus, a modified abstract query (e.g., modified abstract query 262 of FIG. 2) is created that can be transformed into a concrete query as explained above with reference to FIGS. 4-5. In still another embodiment, methods 400 and 500 of FIGS. 4-5 can be implemented as part of the loop consisting of steps 940-950 for generation of the concrete query from the abstract query using the generated optimized data structure table. In other words, the concrete query contributions are generated according to at least a portion of the steps of methods 400 and 500 of FIGS. 4-5 using the generated optimized data structure table. All such implementations are broadly contemplated.

Assume now that in the given example the exemplary abstract query of Table III is transformed into the exemplary SQL query illustrated in Table IX below. By way of example, the query of Table IX below is defined using SQL. However, persons skilled in the art will readily recognize corresponding XML representations, such as used to describe the exemplary abstract query of Table I. Accordingly, it should be noted that implementation of the exemplary query of Table IX is not limited to a particular machine-readable language and that an implementation in any machine-readable language, known or unknown, is broadly contemplated.

TABLE IX
SQL QUERY EXAMPLE

001 SELECT DISTINCT
002 “t1”.“patient_ID” AS “Patient_ID”,
003 case
004 when “t1”.”age” <= 12 then ‘1’
005 else ‘0’
006 end as “Age;Child”,
007 case
008 when “t1”.“age” BETWEEN 13 AND 17 then ‘1’
009 else ‘0’
010 end as “Age;Adolescent”,
011 case
012 when “t1”.“age” BETWEEN 18 AND 64 then ‘1’
013 else ‘0’
014 end as “Age;Adult”,
015 case
016 when “t1”.“age” >= 65 then ‘1’
017 else ‘0’
018 end as “Age;Senior”,
019 case
020 when “t1”.“gender” = ‘M’ then ‘1’
021 else ‘0’
022 end as “Gender;Male”,
023 case
024 when “t1”.“gender” = ‘F’ then ‘1’
025 else ‘0’
026 end as “Gender;Female”,
027 case
028 when “t1”.“gender” = ‘U’ then ‘1’
029 else ‘0’
030 end as “Gender;Unknown”,
031 case
032 when “t2”.“Hct%BId” < “15” then ‘1’
033 else ‘0’
034 end as “Hemoglobin;Low”,
035 case
036 when “t2”.“Hct%BId” BETWEEN “15” AND “25” then ‘1’
037 else ‘0’
038 end as “Hemoglobin;Normal”,
039 case
040 when “t2”.“Hct%BId” > “25” then ‘1’
041 else ‘0’
042 end as “Hemoglobin;High”
043 FROM
044 “CONTACT” “t1”
045 LEFT JOIN “TESTS” “t2” ON “t1”.“patient_ID” =
“t2”.“patient_ID”
046 WHERE
047 ( “t2”.“Hct%BId” < 20 )

The exemplary SQL query of Table IX includes in lines 002-042 concrete query contributions for the result fields of the exemplary abstract query of Table III. Furthermore, a concrete query contribution for the query condition related to the “Hemoglobin” field of line 004 of Table III is included with line 047. By way of example, note that the exemplary optimization data of line 003 of Table V was used to create the concrete query contribution in lines 003-006 of Table IX. Note further that the exemplary query of Table IX is not configured for creating subcolumns related to missing and/or invalid values as described above, for brevity. However, as SQL is well-known in the art, the exemplary query of Table IX is readily understood by persons skilled in the art and is, therefore, not explained in more detail.

Once the loop consisting of steps 940-950 was performed for each result field of the abstract query and, thus, each row in the generated optimized data structure table, processing proceeds with step 960. At step 960, the generated concrete query is executed against the underlying database(s) and a binary result set (e.g., optimized result set 282 of FIG. 2) is obtained.

In the given example, the exemplary concrete query of Table IX is executed against a “contact” (line 044 of Table IX) and a “tests” (line 045 of Table X) table of the underlying database(s) to obtain the binary result set. Assume now that the exemplary result set of Table X below is obtained, wherein “0” and/or null values are left out for clarity. In other words, the exemplary result set of Table X below only illustrates binary “1” values, for simplicity.

TABLE X
BINARY RESULT SET EXAMPLE

| | Patient ID | Age | | | | Gender | | | Hemoglobin | | |
|---|---|---|---|---|---|---|---|---|---|---|---|
| | Patient ID | Child | Adolescent | Adult | Senior | Male | Female | Unknown | Low | Normal | High |
| 001 | | | | | | | | | | | |
| 002 | | | | | | | | | | | |
| 003 | 1 | | 1 | | | | 1 | | | 1 | |
| 004 | 2 | | | 1 | | 1 | | | | 1 | |
| 005 | 3 | | | | 1 | | 1 | | 1 | | |
| 006 | 4 | | | | 1 | 1 | | | 1 | | |
| 007 | 5 | 1 | | | | | 1 | | | 1 | |

The exemplary binary result set of Table X includes four columns (line 001) each representing a result field of the exemplary abstract query of Table III (line 002 of Table II). Each of the “Age”, “Gender” and “Hemoglobin” result fields includes one or more subcolumns as defined by the exemplary concrete query of Table IX. By way of example, the “Hemoglobin” column illustratively includes three subcolumns, “Low”, “Normal” and “High” according to lines 034, 038 and 042 of the exemplary concrete query of Table IX.

It should be noted that the exemplary binary result set of Table X illustratively represents the exemplary result set of Table IV in binary form on the basis of the exemplary optimized data structure table of Table V. For instance, line 002 of the exemplary optimized data structure table of Table V relates to a “14” year old “female” patient having a hemoglobin test value of “19.5”. Using the optimization data in lines 004, 010 and 015 of the exemplary optimized data structure table of Table V, these actual values are represented by the binary value “1” in the subcolumns “Adolescent”, “Female” and “Normal”, respectively. In other words, in the given example the exemplary binary result set of Table X is obtained instead of the exemplary result set of Table IV by executing the exemplary concrete query of Table IX against the underlying database(s).

At step 970, the obtained binary result set is input to the selected analysis routine. The selected analysis routine processes the binary result set and outputs an analyzed result set. The specific analysis of binary result sets using corresponding analysis routines may take many different forms and require a variety of algorithms. However, analysis of binary results sets is well-known in the art and, therefore, not described in more detail, for brevity.

At step 980, the analyzed result set is output to the requesting entity, in one embodiment. For instance, the analyzed result set is displayed to the user using the user interface 210 of FIG. 2. Thus, the user can indicate whether further processing of the analyzed result set is required.

Accordingly, in one embodiment the analyzed result set is processed at step 990. One embodiment of a method 800 for processing an obtained result set according to step 990 of method 900 is described above with reference to FIG. 8.

### Results Optimization

One embodiment of a method 1000 for generating a binary result set (e.g., optimized result set 282 of FIG. 2) from a result set presented in non-binary form (e.g., result set 280 of FIG. 2) according to step 830 of method 800 of FIG. 8 is now described with reference to FIG. 10. In one embodiment, the non-binary result set is retrieved from memory (e.g., storage 138 of FIG. 1). Alternatively, the non-binary result set is determined by executing an abstract query (e.g., abstract query 260 of FIG. 2) against one or more underlying databases (e.g., database 230 of FIG. 2). Assume now by way of example that method 1000 is performed on the exemplary result set illustrated in Table IV above, which is presented in non-binary form.

Method 1000 starts at step 1010, where an analysis routine (e.g., analysis routine 284 of FIG. 2) that requires a binary result set as input is selected. As noted above, the analysis routine can be selected using a suitable GUI screen displayed by the user interface 210 of FIG. 2. Assume that the selected analysis routine does not accept streamed data as input. In other words, a pre-stored binary result set is required as input. In this case, the selected analysis routine may have an “allowStreamResults” attribute as mentioned above that can be set to “No” in order to indicate that the analysis routine does not accept streamed data as input. Accordingly, the remaining steps of method 1000 are performed to generate such a binary result set from the result set in non-binary form.

At step 1020, a loop consisting of steps 1020 and 1025 is entered for each result field (e.g., the result fields in line 001 of the exemplary result set of Table IV) of the non-binary result set. At step 1025, a process for determining optimization data (described by way of example in Table V above) for the result field is performed. To this end, an underlying data abstraction model (e.g., data abstraction model 292 of FIG. 2) having a logical field that defines the result field is accessed. If the logical field includes one or more value constraints that can be used for the generation of binary result data, the value constraint(s) are retrieved and corresponding optimization data is determined. An exemplary method for determining optimization data for result fields is described below with reference to FIG. 11. In the given example, the loop consisting of steps 1020 and 1025 is performed for each result field in line 001 of the exemplary result set of Table IV.

Using the determined optimization data, an optimized data structure table is generated by the loop consisting of steps 1020 and 1025 as described above with reference to steps 920-930 of FIG. 9. Accordingly, assume that in the given example the exemplary optimized data structure table of Table V above is created for the exemplary non-binary result set of Table IV above.

At step 1030, an empty optimized result set is created. For instance, an empty data structure such as a database table is created in the underlying database(s) or in computer memory (e.g., memory 116 of FIG. 1).

At step 1040, an optimized data structure is created in the empty optimized result set using the optimized data structure table. More specifically, corresponding columns and subcolumns are created in the empty optimized result set as defined by the optimized data structure table. For instance, in the given example an empty optimized result set having the columns and subcolumns of lines 001-002 of the exemplary binary result set of Table X is created in steps 1030-1040 on the basis of the exemplary optimized data structure table of Table V.

At step 1050, a loop consisting of steps 1050-1065 is entered for each row of the non-binary result set. At step 1060, a loop consisting of steps 1060-1065 is entered for non-binary result data of each result field of a respective row of the non-binary result set. At step 1065, binary result data is generated for the non-binary result data of the result field. In the given example, the generation is performed using the rules defined by the optimization data in Table V above.

Assume that in the given example the loop consisting of steps 1050-1065 is initially entered for the row of the exemplary result set that is represented by line 002 of Table IV. Accordingly, the loop consisting of steps 1060-1065 is successively entered for the “Patient ID”, “Age”, “Gender” and “Hemoglobin” values “1”, “14”, “Female” and “19.5”. In other words, the loop consisting of steps 1050-1065 is performed four times with respect to line 002 of Table IV. Once for the “Patient ID” value “1”, whereby the non-binary value “1” is created in the “Patient ID” column of the binary result set. Then, for the “Age” value “14”, whereby the binary value “1” is created in the subcolumn “Adolescent” of the “Age” column. Then, for the “Gender” value “Female”, whereby the binary value “1” is created in the subcolumn “Female” of the “Gender” column, and finally for the “Hemoglobin” value “19.5”, whereby the binary value “1” is created in the subcolumn “Normal” of the “Hemoglobin” column. Subsequently, the loop consisting of steps 1050-1065 is entered for the remaining rows of the exemplary result set of Table IV, which are represented by lines 003-006 of Table IV.

Once the loop consisting of steps 1050-1065 has been performed for each result field of each row of the non-binary result set, processing proceeds with step 1070. In the given example, processing of the loop consisting of steps 1050-1065 is complete when lines 002-006 of Table IV have been processed, whereby the binary result set which corresponds in the given example to the exemplary binary result set of Table X above is obtained.

At step 1070, the obtained binary result set is input to the selected analysis routine. The selected analysis routine processes the binary result set and outputs an analyzed result set. However, as mentioned above analysis of the binary result set using a selected analysis routine is well-known in the art and, therefore, not described in more detail for brevity.

At step 1080, the analyzed result set is output to the requesting entity, in one embodiment. For instance, the analyzed result set is displayed to the user using the user interface 210 of FIG. 2. Thus, the user can indicate whether further processing of the analyzed result set is required.

In one embodiment, the analyzed result set is processed at step 1090. One embodiment of a method 800 for processing an obtained result set according to step 1090 of method 1000 is described above with reference to FIG. 8.

### Field Optimizaiton

One embodiment of a method 1100 for generating an optimized data structure table (e.g., the exemplary optimized data structure table of Table V above) according to step 930 of method 900 of FIG. 9 or step 1025 of method 1000 of FIG. 10 is now described with reference to FIG. 11. Method 1100 is performed on result fields included with one of (i) an abstract query (e.g., abstract query 260 of FIG. 2) and (ii) a non-binary result set (e.g., result set 280 of FIG. 2). In one embodiment, the method 1100 is performed by the optimizer unit 270 of FIG. 2.

Method 1100 is performed for each of the result fields and starts for a given result field at step 1110, where logical data is retrieved for the result field. To this end, an underlying data abstraction model (e.g., data abstraction model 292 of FIG. 2) is accessed that defines a logical field (e.g., logical fields 308 of FIGS. 3B-C) that corresponds to the given result field. Then, it is determined whether the logical field defines one or more value constraints for the given result field. If so, the value constraint(s) is determined.

For instance, in the given example method 1100 is successively executed on each of the result fields in line 002 of the exemplary abstract query of Table III or line 001 of the exemplary non-binary result set of Table IV. Accordingly, at step 1110 the logical fields “Patient ID”, “Age”, “Gender” and “Hemoglobin” defined in lines 004-008, 033-049, 050-059 and 062-068 of Table II, respectively, are accessed. By way of example, the “Patient ID” field is accessed in an execution of method 1100 for the “Patient ID” result field, the “Age” field is accessed in an execution of method 1100 for the “Age” result field, the “Gender” field is accessed in an execution of method 1100 for the “Gender” result field, and the “Hemoglobin” field is accessed in an execution of method 1100 for the “Hemoglobin” result field. From the “Age” field the exemplary value constraints defined in Table VI above are retrieved for the “Age” result field. From the “Gender” field the exemplary value constraints defined in Table VII above are retrieved for the “Gender” result field. From the “Hemoglobin” field the exemplary value constraints defined in Table VII above are retrieved for the “Hemoglobin” result field. However, as noted above the “Patient ID” field does not define any value constraints for the “Patient ID” result field.

In one embodiment, retrieving the value constraints for the result given field includes determining required subcolumns for each column representing the given result field in a corresponding binary result set (e.g., optimized result set 282 of FIG. 2). For instance, for the “Age” result field an “Age” column is created in the corresponding binary result set (line 001 of Table X). Furthermore, as noted above four subcolumns need to be created for the “Age” column, i.e., a “Child”, “Adolescent”, “Adult” and “Senior” subcolumn (lines 001-004 of Table VI).

At step 1120, a loop consisting of steps 1120 and 1130 is performed to generate optimization data in an optimized data structure table (e.g., the exemplary optimized data structure table of Table IX) for the corresponding binary result set. More specifically, the loop is entered to generate suitable optimization data for each column and subcolumn that needs to be created for the corresponding binary result set. At step 1130, the suitable optimization data is created for the column and/or subcolumn in the optimized data structure table. Once the loop consisting of steps 1120-1130 was performed for each column and/or subcolumn retrieved for the given result field, processing proceeds with step 1140.

In the given example, assume that method 1100 is initially executed for the “Patient ID” column. As no value constraints and, thus, no subcolumns were retrieved for the “Patient ID” result field, no optimization data is created for this field. Accordingly, line 002 of the exemplary optimized data structure table of Table V is created. However, in the execution of method 1100 for the “Age” column, the loop consisting of steps 1120-1130 is initially entered for the “Child” subcolumn (line 001 of Table VI), whereby line 003 of the exemplary optimized data structure table of Table V is created. Subsequently, the loop is performed for the “Adolescent”, “Adult” and “Senior” fields, whereby lines 004-006 of Table V are created.

In one embodiment, when the loop consisting of steps 1120-1130 was performed for each subcolumn of the given result field, optimization data related to missing and/or invalid data is created for the given result field in the optimized data structure table. For instance, when in the given example lines 003-006 of Table V were created for the “Child”, “Adolescent”, “Adult” and “Senior” subcolumns of the “Age” result field, lines 007-08 of Table V are created as explained above for missing and invalid age values, respectively. However, it should be noted that creation of optimization data for missing and/or invalid data is merely described by way of example and not limiting of the invention. Instead, creation of such optimization data is optional and alternative implementations without such optimization data are broadly contemplated.

At step 1140, the generated optimized data structure table is returned. Processing then continues at step 920 of method 900 of FIG. 9 or step 1020 of method 1000 of FIG. 10.

While the foregoing is directed to embodiments of the present invention, other and further embodiments of the invention may be devised without departing from the basic scope thereof, and the scope thereof is determined by the claims that follow.

What is claimed is:

1. A method of generating a binary result set from non-binary data, comprising:
receiving a request for a binary result set for an object containing result fields; and
operating on the object to generate the binary result set from non-binary result data associated with the result fields; wherein operating on the object comprises:
accessing at least one field definition for at least one of the result fields to retrieve one or more value constraints that define allowable values for the at least one result field; and
rendering the non-binary result data associated with the result fields in a binary format using the one or more retrieved value constraints, whereby the binary result set is generated.

2. The method of claim 1, wherein the object is a result set including the non-binary result data returned for a previously executed query.

3. The method of claim 2, wherein rendering the non-binary result data associated with the result fields in a binary format comprises:
generating an empty binary result set on the basis of the one or more retrieved value constraints; and
populating the empty binary result set with binary values each representing non-binary result data included with the returned result set.

4. The method of claim 3, wherein populating the empty binary result set comprises:
creating a corresponding binary value in the empty binary result set for each of:
(i) a value included with the non-binary result data;
(ii) an invalid value included with the non-binary result data; and
(iii) a value that is missing in the non-binary result data.

5. The method of claim 3, wherein generating the empty binary result set comprises, for each result field having one or more value constraints, generating at least one column for each value constraint in the empty result set; and wherein populating the empty binary result set comprises generating a binary value for corresponding non-binary data in at least one of the generated columns.

6. The method of claim 1, wherein the object is a query requesting the non-binary result data.

7. The method of claim 6, wherein rendering the non-binary result data associated with the result fields in a binary format comprises:
modifying the query on the basis of the one or more retrieved value constraints in a manner that formats the non-binary result data in a binary form; and
executing the query against an underlying database to retrieve the non-binary result data from the database.

8. The method of claim 7, wherein the modified query is configured for generating a binary value for each of:
(i) a valid value included with the non-binary result data;
(ii) an invalid value included with the non-binary result data; and
(iii) a missing value that is missing in the non-binary result data.

9. The method of claim 1, wherein at least one of the retrieved value constraints defines for the allowable values at least one of:
(i) one or more value classes;
(ii) an enumerated value list; and
(iii) an allowable value range.

10. The method of claim 1, wherein operating on the object to generate the binary result set comprises:
formatting the binary result set according to a predefined input format of an analysis routine configured to process the binary result set.

11. The method of claim 1, wherein operating on the object to generate the binary result set comprises, for each result field having one or more value constraints, generating a column corresponding to each value constraint and generating a binary value for one or more of the generated columns.

12. The method of claim 1, wherein the object is one of (i) an abstract query including the results fields and (ii) a result set including the results fields returned for a previously executed abstract query; and wherein the at least one field definition is included in a data abstraction model, and wherein each field definition specifies an access method for accessing data in an underlying database corresponding to the field definition, and wherein the abstract query and the previously executed abstract query are composed on the basis of the data abstraction model and transformed at runtime into respective physical queries constructed according to a schema of the database.

13. A computer-readable medium containing a program which, when executed by a processor, performs a process for generating a binary result set from non-binary data, the process comprising:
receiving a request for a binary result set for an object containing result fields; and
operating on the object to generate the binary result set from non-binary result data associated with the result fields; wherein operating on the object comprises:
accessing at least one field definition for at least one of the result fields to retrieve one or more value constraints that define allowable values for the at least one result field; and
rendering the non-binary result data associated with the result fields in a binary format using the one or more retrieved value constraints, whereby the binary result set is generated.

14. The computer-readable medium of claim 13, wherein the object is a result set including the non-binary result data returned for a previously executed query.

15. The computer-readable medium of claim 14, wherein rendering the non-binary result data associated with the result fields in a binary format comprises:
generating an empty binary result set on the basis of the one or more retrieved value constraints; and
populating the empty binary result set with binary values each representing non-binary result data included with the returned result set.

16. The computer-readable medium of claim 15, wherein generating the empty binary result set comprises, for each result field having one or more value constraints, generating at least one column for each value constraint in the empty result set; and wherein populating the empty binary result set comprises generating a binary value for corresponding non-binary data in at least one of the generated columns.

17. The computer-readable medium of claim 13, wherein the object is a query requesting the non-binary result data.

18. The computer-readable medium of claim 17, wherein rendering the non-binary result data associated with the result fields in a binary format comprises:
modifying the query on the basis of the one or more retrieved value constraints in a manner that formats the non-binary result data in a binary form; and
executing the query against an underlying database to retrieve the non-binary result data from the database.

19. The computer-readable medium of claim 13, wherein at least one of the retrieved value constraints defines for the allowable values at least one of:
(i) one or more value classes;
(ii) an enumerated value list; and
(iii) an allowable value range.

20. The computer-readable medium of claim 13, wherein operating on the object to generate the binary result set comprises:
formatting the binary result set according to a predefined input format of an analysis routine configured to process the binary result set.

21. The computer-readable medium of claim 13, wherein operating on the object to generate the binary result set comprises, for each result field having one or more value constraints, generating a column corresponding to each value constraint and generating a binary value for one or more of the generated columns.

22. The computer-readable medium of claim 13, wherein the object is one of (i) an abstract query including the results fields and (ii) a result set including the results fields returned for a previously executed abstract query; and wherein the at least one field definition is included in a data abstraction model, and wherein each field definition specifies an access method for accessing data in an underlying database corresponding to the field definition, and wherein the abstract query and the previously executed abstract query are composed on the basis of the data abstraction model and transformed at runtime into respective physical queries constructed according to a schema of the database.
